(19) United States
(12) Patent Application Publication
(10) Pub. No.: US 2016/0186023 A1
(43) Pub. Date: Jun. 30, 2016

(54) ADDITIVE FOR CAUSTIC REMOVABLE HOT MELT ADHESIVES AND FORMULATIONS CONTAINING THE SAME

(71) Applicant: Fina Technology, Inc., Houston, TX (US)

(72) Inventors: William R. DOUGHERTY, Strasburg, PA (US); Nestor P. HANSEN, Coatesville, PA (US)

(73) Assignee: Fina Technology, Inc., Houston, TX (US)

(21) Appl. No.: 14/978,395

(22) Filed: Dec. 22, 2015

Related U.S. Application Data
(60) Provisional application No. 62/097,883, filed on Dec. 30, 2014.

(51) Int. Cl. C09J 153/02; C08L 25/14; C08L 51/00

(52) U.S. Cl. CPC C09J 153/02; C08L 51/003; C08L 25/14

(57) ABSTRACT

An additive for imparting caustic removability to a hot melt adhesive includes a hydrocarbon copolymer containing one or more dicarboxylic acid moieties in at least partial ester form and a C5 hydrocarbon polymer comprising a polymeric backbone and, pendent thereon, one or more dicarboxylic acid moieties in at least partial ester form. The hydrocarbon copolymer and a C5 hydrocarbon polymer may have a weight average molecular weight less than 50,000, a flashpoint greater than or equal to 150° C., and may be soluble in a caustic solution having a pH of 8 or greater. A caustic removable hot melt adhesive composition may include the additive composition, a block copolymer, a tackifler, and/or a processing oil. The caustic removable hot melt adhesive composition may be applied to a label to adhere the label to the surface of an article, such as a recyclable bottle.

### CROSS REFERENCE TO RELATED APPLICATION

This application claims the benefit of U.S. Provisional Application No. 62/097,883 filed on Dec. 30, 2014, the contents of which are incorporated herein by reference in their entirety.

### FIELD OF INVENTION

This invention relates to hot melt adhesive formulations which have properties enabling caustic removability. More particularly, the invention relates to an adhesive additive composition for imparting caustic removability to a hot melt adhesive. Additionally, this invention relates to the hot melt adhesive composition including the additive composition, to the adhesive labels which employ the hot melt adhesive composition, and to the articles upon which the adhesive label is adhered with the adhesive composition.

### BACKGROUND OF THE INVENTION

Hot melt adhesives typically exist as entirely solid materials which do not contain or require any solvents. They are solid materials at ambient room temperature, but can be converted to a flowable liquid or fluid state by the application of heat, in which state they may be applied to a substrate. On cooling, the adhesive regains its solid form and gains its cohesive strength. In this regard, hot melt adhesives differ from other types of adhesives, such as water-based adhesives, which achieve the solid state by evaporation, removal of solvents, polymerization, or other means.

These adhesives are particularly useful in the manufacture of a variety of Industrial or consumer goods where bonding of various substrates is necessary. An advantage of hot melt adhesives is the absence of a liquid carrier, as would be the case for water-based or solvent-based adhesives, which requires a drying step during application of the adhesive. Suitable hot melt adhesives possess the appropriate bond strength to adhere the substrates involved, and also demonstrate adequate flexibility, no staining or bleed through of the substrate, suitable viscosity and open time to function on a variety of substrates, acceptable stability under storage conditions, and acceptable thermal stability under normal application temperature.

Hot melt adhesives may be formulated to be relatively hard and free of tack or, in contrast, to be pressure sensitive, i.e., relatively soft and tacky at room temperature. Hot melt adhesives are increasingly utilized for affixing labels to various surfaces, such as to glass or plastic bottles. Pressure sensitive hot melt adhesives for labeling are usually categorized as either removable or permanent. Permanent adhesives are formulated to cause the label to tear upon removal from the surface. On the contrary, removable adhesives should allow the label to be removed from the surface with a clean release, i.e. leaving no residue and without the tear of the label stock which occurs in a permanent adhesive application.

Solid hot melt adhesives for permanent adhesives have been widely used for many years. However, a hot melt adhesive, and more particularly a hot melt pressure sensitive adhesive, that gives good removability has not been available. Current removable adhesives are supplied for label stock from acrylic lattices and solvented solution adhesives. Both of these materials have high molecular weight polymers that reduce flow on a surface to prevent build up of adhesion. In contrast, hot melt adhesives, in particular hot melt pressure sensitive adhesives, are based on materials having lower molecular weight polymers and high amounts of very low molecular weight components that make reduced flow or wetting on a surface easier.

Many different polymers have been used in hot melt adhesives employed in the construction of industrial or consumer goods. Typical hot melt adhesives have employed polymers which have included tri-block copolymers such as styrene-isoprene-styrene (SIS); styrene-butadiene-styrene (SBS); styrene-isoprene-butadiene-styrene (SIBS); styrene-ethylene-propylene-styrene (SEPS); styrene-ethylene-butylene-styrene (SEBS); ethylene-vinyl acetate (EVA) copolymers; and/or amorphous poly-alpha-olefin (APAO). Although these polymers, when properly blended, provide adhesion to most substrates, they are not suitable for certain particular uses. One shortcoming of the prior hot melt adhesives concerns their removability, which is an Important feature for purposes of recycling the articles to which they are applied.

To improve removability of the hot melt adhesive, efforts have been made in increasing the water-solubility or water-dispersibility characteristics of the adhesive. For example, one known water sensitive hot melt adhesive composition which may be utilized in the manufacturing of disposable goods, especially disposable nonwoven articles, combines high dry bond strength with increased water solubility, thereby permitting the component elements of the disposable article to be recycled or otherwise disposed of in an environmentally friendly manner (i.e., degraded). Other adhesives relate to a water-soluble or water-dispersible hot melt composition based on graft copolymers. These water-removable hot melt adhesives are used for labelling returnable bottles at high speeds, wherein the labels can be removed by brief soaking in hot water. However, these water-soluble compositions do not adhere well for labels onto glass bottles, where water-resistant characteristics are desired as much as the clean removability of pressure sensitive labels.

Conventional styrene-isoprene-styrene (SIS) block copolymer/hydrocarbon (HC) tackifier-based hot melt adhesives have been used to adhere labels to glass bottles for decades. One of the beneficial properties of these types of adhesives for this application is that they can withstand a 7-day water immersion test. Accordingly, these types of adhesives are used because of their favorable water-resistant characteristics. However, this presents a difficult challenge when the labels and adhesives need to be removed in a glass bottle recycling process. Hot caustic baths are successfully used to remove many water-based label adhesives. However, the hot melt adhesives are very resistant to caustic baths. Thus, there is a need for improved hot-melt adhesive compositions.

### SUMMARY OF THE INVENTION

A new additive composition has now been developed which imparts caustic removability to conventional hot melt adhesives without significantly sacrificing adhesive performance. For example, particular additives of the present invention impart caustic removability to styrene-isoprene-styrene (SIS) block copolymer/hydrocarbon (HC) tackifler-based hot melt adhesives. An adhesive containing the additive composition may be formulated to achieve similar water resistance and adhesive strength properties as when the additive composition is not present, while enabling the complete removability of the labels in caustic baths for recycling purposes. The adhesive containing the additive composition may be applied to a substrate, such as paper for an adhesive label, for adhesion to an article such as a glass bottle or container. The presence of such an additive composition in a hot melt adhesive composition improves the caustic removability of the adhesive while maintaining the viscoelastic performance characteristics and adhesive properties of the hot melt adhesive composition. Advantageous properties of the additive compositions disclosed herein include the following improvements over prior additive compositions:
improved adhesive strength of the hot melt adhesive is observed compared to previously known caustic removable hot melt adhesive compositions;
a high flashpoint, greater than or equal to 150° C., provides a safer additive composition for processing, material handling, and storage;
additive compositions may be FDA-approved for use with food contact surfaces, such as adhesives approved under 21 C.F.R. Sec. 175.105; and
less additive may be added to a hot melt adhesive composition in order to achieve similar or Improved effects compared to previously known caustic removable hot melt adhesive compositions, thereby reducing raw material costs.

The present invention relates to an adhesive additive composition for imparting caustic removability to a hot melt adhesive. Additionally, this invention relates to a hot melt adhesive composition, particularly a hot melt pressure sensitive adhesive composition, which includes the adhesive additive composition. The present invention also relates to a hot melt adhesive label, which includes the hot melt adhesive composition and the adhesive additive composition, that is removable by a caustic solution. Furthermore, the invention relates to an article upon which the adhesive label is adhered with use of the adhesive composition of the invention.

According to a first embodiment, the present invention relates to an additive composition for imparting caustic removability to a hot melt adhesive. The additive composition comprises low molecular weight ester functionalized polymers, which are capable of imparting acid functionality to the hot melt adhesive. As used herein, the term “low molecular weight” means a number average molecular weight less than about 50,000. The term “polymer” is to be interpreted herein as a naturally occurring or synthetic compound consisting of large molecules made up of a linked series of repeated monomers obtained by, for example, a polymerization process.

In one embodiment, the additive composition comprises a C5 hydrocarbon polymer and, pendent thereon, one or more dicarboxylic add moieties in at least partial ester form. In at least one embodiment of the present invention, the hydrocarbon polymer may contain aliphatic, as well as aromatic repeating units. For example in one embodiment, the C5 hydrocarbon polymer may comprise up to 30% by weight of aromatic repeating units. In some embodiments of the present invention, the C5 aliphatic hydrocarbon polymer may be an at least partial ester of a maleic anhydride grafted copolymer. The term “graft copolymer” is meant to mean a polymer in which the main backbone chain has attached to it at various points side chains containing different atoms or groups from those in the main chain. The main chain may be a copolymer or may be derived from a single monomer.

In another embodiment, the additive composition comprises an esterified low molecular weight α,β ethylenically unsaturated anhydride-containing or acid-containing hydrocarbon polymer, wherein the hydrocarbon polymer is selected from the group consisting of an anhydride homopolymer, an anhydride olefin copolymer, an anhydride aromatic hydrocarbon copolymer, and combinations and mixtures thereof.

In at least one particular embodiment, the additive composition comprises an at least partial ester of a low molecular weight C5 aliphatic hydrocarbon polymer and an esterified low molecular weight α,β ethylenically unsaturated anhydride-containing or acid-containing hydrocarbon polymer, wherein the hydrocarbon polymer is selected from the group consisting of an anhydride homopolymer, an anhydride olefin copolymer, an anhydride aromatic copolymer, and combinations and mixtures thereof. In some embodiments of the present invention, the additive composition includes an esterified low molecular weight maleic anhydride vinyl aromatic copolymer, such as a low molecular weight styrene-maleic anhydride (SMA) copolymer that is at least partially esterified with a glycol and a maleated low molecular weight aliphatic C5 hydrocarbon polymer that is at least partially esterified with a linear or branched aliphatic monoalcohol.

As used herein throughout the specification and the claims, “esterified” is equivalent to “at least partially esterified” and means that an anhydride or dicarboxylic add functional group has been reacted with a reagent, such as an alcohol, to form at least one ester group.

As used herein throughout the specification and the claims, a “C5 hydrocarbon polymer” means a polymer produced by the polymerization of a light steam-cracked naphtha fraction with a boiling point in the range of 25 to 200° C. and containing a mixture of C4 to C6 mono and di-olefins and optional aromatic monomers as the primary active ingredients utilizing a common catalyst. The reaction product is isolated by removing unreacted materials with heat and vacuum.

Exemplary additive compositions of the present invention include a low molecular weight styrene-maleic anhydride (SMA) copolymer at least partially esterified with methoxy polyethylene glycol (mPEG) and a C5 hydrocarbon polymer/maleic anhydride graft co-polymer at least partially esterified with a linear or branched aliphatic C12 to C18 monoalcohol.

The additive compositions may impart caustic removal properties to a conventional hot melt adhesive formulation. Adhesives formulated with such additives can be used in hot melt adhesive labels, particularly in hot melt pressure sensitive labels for recyclable glass articles, such as bottles. The labels can be removed with caustic, such as in a hot caustic bath, when the objects are recycled. Without being held to theory, it is believed that the acid and/or anhydride groups of the additive components impart caustic solubility to the otherwise insoluble hot melt adhesive components. The dicarboxylic acids, in at least partial ester form, of the ester functionalized polymers are believed to contribute to the desirable properties of the additive and the resulting adhesive formulation. For example, the additive imparts caustic solubility to the hot melt adhesive composition comprising a block copolymer. More specifically, the additive composition is compatible with each domain of the block copolymer, such that the add functionality of the additive composition may be imparted into the block copolymer. “Compatible” as used herein means that when the additive(s) are present in the adhesive such that there is no observable change in peaks in tangent delta as measured by dynamic mechanical analysis such as a torsional melt rheometer. In other words, the desired adhesive properties of the hot melt adhesive are retained even though the caustic removability property has been imparted by the addition of the additive composition.

In another embodiment, the formulation includes a caustic removable hot melt adhesive composition, more particularly a hot melt pressure sensitive adhesive composition, which includes a hot melt adhesive additive. The hot melt adhesive composition is caustic removable and includes a hot melt adhesive additive which comprises an additive composition for imparting caustic removability to a hot melt adhesive. The additive composition comprises low molecular weight ester functionalized polymers which are capable of imparting add functionality to the hot melt adhesive; an adhesive resin selected from the group consisting of styrene-isoprene block copolymers, polyacrylate resins, poly ethylene vinyl acetate (EVA) resins, polystyrene butadiene resins, random styrene-butadiene (SBR) copolymers, styrene—butadiene block copolymers, styrene-ethylene-butylene-styrene (SEBS) block copolymers, amorphous poly-α olefin (APAO) resins, and mixtures thereof; a tackifier; and/or a processing oil. The present invention has a particular usefulness for labels on products which are to be recycled.

In yet another embodiment, a caustic removable adhesive label is provided comprising a substrate and a caustic removable hot melt adhesive composition that includes at least one hot melt adhesive additive composition. The hot melt adhesive additive composition comprises an additive composition for imparting caustic removability to a hot melt adhesive. The additive composition comprises low molecular weight ester functionalized polymers which are capable of imparting acid functionality to the hot melt adhesive; an adhesive resin selected from the group consisting of styrene-isoprene block copolymers (such as styrene-Isoprene-styrene (SIS) block copolymers), hydrocarbon tackifying resins, polyacrylate resins, poly ethylene vinyl acetate (EVA) resins, polystyrene butadiene resins, random styrenebutadiene (SBR) copolymers, styrene-butadiene block copolymers (such as a styrene-butadlene-styrene (SBS) block copolymer), styrene-ethylene-butylene block copolymers (such as a styrene-ethylene-butylene-styrene (SEBS) block copolymer), amorphous poly-α olefin (APAO) resins, and mixtures thereof; a tackifler; and/or a processing oil. The adhesive composition is applied to the substrate for adhesion to an article. The label of the present invention may be a label which, after application of the caustic removable hot melt adhesive composition, may be adhered to an article such as a glass bottle. In at least one embodiment, the caustic removable adhesive label contains a hot melt adhesive composition including an additive composition, in which the additive composition comprises a combination of resins. Exemplary two-part additive compositions of the present invention may include a combination of an at least partial ester of a maleated aliphatic C5 hydrocarbon polymer and an at least partial ester of a low molecular weight maleic anhydride vinyl aromatic copolymer. The adhesive additive composition may have a flashpoint greater than or equal to 150° C. and may be soluble at room temperature or higher in a caustic (basic) solution having a pH greater than 8. It has been found that longer chain esters incorporated into the polymers of the additive compositions according to the present invention improve efficiency because less additive may be employed in the hot melt adhesive compositions to impart caustic removability without a loss in adhesive properties.

In another embodiment, an article is provided having a caustic removable adhesive label. Particularly, the article is a container and a caustic removable adhesive label is adhered thereto. The label comprises a substrate, such as paper, and a caustic removable hot melt adhesive composition. The hot melt adhesive composition may comprise an additive composition for imparting caustic removability to a hot melt adhesive. The additive composition comprises low molecular weight ester functionalized polymers which are capable of imparting acid functionality to the hot melt adhesive. The additive may have a flashpoint greater than or equal to 150° C. and may be soluble in a caustic solution having a pH greater than 8. The container may be made of any suitable material including, for example, glass, metal (e.g., stainless steel), or plastic (e.g., a polyolefin such as high density polyethylene). The label adheres to the article with good adhesion properties, and the article and label are water resistant. The label becomes removable from the article upon being submerged in, or otherwise treated with, a caustic bath having a pH greater than 8.

### DETAILED DESCRIPTION OF THE INVENTION

The additive composition, which imparts the caustic removability property to a conventional hot melt adhesive formulation, comprises low molecular weight ester functionalized polymers that are capable of imparting acid functionality to the hot melt adhesive. More specifically, the additive composition includes an at least partial ester of a low molecular weight C5 aliphatic hydrocarbon polymer and an esterified low molecular weight α,β ethylenically unsaturated anhydride-containing or acid-containing hydrocarbon polymer, wherein the hydrocarbon polymer is selected from the group consisting of an anhydride homopolymer, an anhydride olefin copolymers, an anhydride aromatic copolymer, and combinations and mixtures thereof. The ester-functionalized polymers may have a low molecular weight defined as a weight average molecular weight less than about 50,000. The polymers may be, for example, a homopolymer of a C4 to C10, preferably C5, monomer, or a copolymer of two or more C4 to C10 monomers. The hydrocarbon may be aliphatic, aromatic, or a combination thereof and include one or more dicarboxylic add moieties either in the polymeric backbone or pendent thereon. The one or more dicarboxylic add moieties may be, for example, an at least partial ester of a dicarboxylic acid moiety. Such dicarboxylic acid moieties may be derived from, for example, a functionalizing agent selected from the group consisting of maleic acid, maleic anhydride, fumaric acid, itaconic acid, tetrahydrophthalic acid, and tetrahydrophthalic anhydride, and combinations thereof.

In at least one embodiment of the present invention, the low molecular weight ester functionalized polymer includes an at least partial ester of a maleinized C5 hydrocarbon polymer, preferably an aliphatic C5 hydrocarbon polymer. As used herein, the terms “maleated” is equivalent to “maleinized” and means that a maleic anhydride functionalizing agent is grafted or otherwise affixed to the polymeric backbone to form a maleated or maleinized graft copolymer. The C5 hydrocarbon polymer is first maleated, using processes which are known by those having skill in the art, followed by esterification, which is accomplished by reacting the maleic anhydride grafted onto the C5 hydrocarbon polymer with a C12 to C18 linear or branched aliphatic monoalcohol, preferably a C16 or greater monoalcohol, provided that at least a portion of the acid groups in the polymer are in ester form, approximately 25 to 100% esterification, more preferably 50 to 100%. The maleated C5 hydrocarbon polymer may also be hydrogenated to remove unsaturation before being esterified. The monoalcohol may be alkoxylated, such as with up to 16 alkoxy units from an ethoxy group and/or a propoxy group. The at least partial ester of a maleinized C5 hydrocarbon polymer is soluble to any degree in basic pH solutions, and is compatible with ethylene, butadiene, and isoprene, such that the additive will impart add functionality to the non-aromatic containing domain of a block co-polymer of a hot melt adhesive composition. The degree of maleinization (or maleation) of the polymeric hydrocarbon may range from the least amount needed to render a given hydrocarbon partially soluble in a basic pH solution having a pH greater than 8, to as high a level of maleinization as is achievable, while retaining compatibility with the hot melt adhesive formulation components. The maleated C5 hydrocarbon polymer may have, for example, a maleic anhydride content (i.e., is maleated or maleinized) from 1% to 50% wt/wt, more preferably 5% to 30% wt/wt. In a preferred embodiment of the present invention, the additive composition includes a 10% maleated derivative of a C5 hydrocarbon polymer which has been at least partially esterified with a monoalcohol.

Any process or component known in the art may be utilized to esterify the additive components of the present invention. The additive components may be esterified, for example with respect to the maleated C5 hydrocarbon polymer, with an alcohol, more particularly by an aliphatic, linear, or branched C12-C18 monoalcohol, alternatively a C12-C16 monoalcohol. Also, a mixture of such alcohols may be suitable. The alcohol is provided so as to esterify between about 50 and about 85 mole percent of the pendent dicarboxylic acid moieties of the polymer. Typically, the esterification reaction does not go fully to completion; thus, a slight excess of the alcohol is unreacted, i.e., between about a 1 and about 5 mole % excess over the desired degree of esterification. As known in the art, the rate of esterification may be controlled or accelerated using a suitable catalyst (e.g., acid, tin compounds).

An exemplary embodiment of a process for producing an at least partial ester of a maleic anhydride grafted C5 hydrocarbon polymer according to the present invention includes charging a C5 hydrocarbon polymer and Maleic Anhydride (MA) into a clean reactor equipped with an agitator. The proportion of C5 hydrocarbon polymer to MA may be selected based on the desired degree of maleation. The materials are heated to about 220° C. and held at that temperature for approximately 4 hours. After 4 hours any excess MA is removed with heat and vacuum. The molten mixture is cooled to an appropriate temperature to allow for the safe addition of the desired alcohol in an approximately stoichiometric amount for the approximately complete esterification of the MA. After adding the alcohol the reaction is heated for 2 hours at 100° C. and then sampled to determine extent of esterification by monitoring the elimination of the anhydride peak by Fourier transform infrared spectroscopy (FTIR). The temperature is held for additional time, if needed, checking the anhydride peak every 30 minutes. The reaction is complete when the peak is near zero and essentially constant for two readings.

In another embodiment, low molecular weight ester functionalized polymers are provided that include an esterified low molecular weight α,β ethylenically unsaturated anhydride-containing or add-containing hydrocarbon polymer, wherein the hydrocarbon polymer is selected from the group consisting of an anhydride homopolymer, an anhydride olefin copolymers, an anhydride aromatic copolymer, and combinations and mixtures thereof. More preferably, the low molecular weight ester functionalized polymers include an at least partial ester of a maleic anhydride hydrocarbon copolymer. The term “hydrocarbon copolymer,” as used herein, is meant to define a class which includes those hydrocarbons copolymerized with aromatic-containing hydrocarbon monomers, up to and Including C10 hydrocarbons. For example hydrocarbon copolymers may contain styrene, alpha methyl styrene, indene, or other C4-C10 hydrocarbons. In such embodiments, the dicarboxylic add ester functional groups may be directly introduced onto the polymer backbone by using, for example, an ester of maleic acid. Alternatively, a diacid or anhydride functionalizing agent, such as maleic anhydride, may be copolymerized with aromatic-containing hydrocarbon monomers and then reacted with an esterifying agent, reacting 25 to 100% of the available anhydride functionality, preferably 50 to 100%.

In a particular embodiment, the ester functionalized polymer is an at least partial ester of a low molecular weight α,β ethylenically unsaturated anhydride-containing or acid-containing polymer which may be copolymers of the anhydride or acid with a co-monomer selected from vinyl aromatic monomers such as, for example, vinyl toluenes, styrene, and alpha methyl styrene, or from ethylene and/or propylene. Preferably, the molar ratio of the co-monomer to the anhydride or acid ranges from about 1:1 to 3:1. The carboxylic anhydride vinyl aromatic copolymer may be partially esterified with a water-soluble glycol, preferably ethylene glycol, polyethylene glycol, or methoxy polyethylene glycol, most preferably a methoxy polyethylene glycol (mPEG), wherein the molecular weight of the mPEG is about 200 to 2000, more preferably about 200 to 500, most preferably about 350. The degree of monoesterification of the carboxylic anhydride copolymer may range, for example, from 25-100% of the Initial anhydrides, preferably from 50-80% of the initial anhydrides. Additionally, the carboxylic anhydride vinyl aromatic copolymer can be any partial monoester of the copolymer which has a flashpoint greater than 150° C. and is soluble to any degree in basic pH solutions having a pH greater than 8. Anhydride groups, ester groups, as well as free acid groups or carboxylate salt groups may be present in the carboxylic anhydride vinyl aromatic copolymer. As a particular example, the anhydride-containing or acid-containing copolymer is a styrene-maleic anhydride copolymer, particularly with a molar ratio S:MA of styrene (S) to maleic anhydride (MA) ranging from about 1:1 to 3:1.

In at least one embodiment, the low molecular weight styrene-maleic anhydride (SMA) may have a structure according to Formula I:

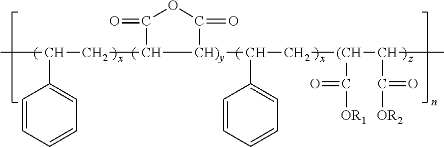

wherein n, R₁, R₂, x, y, and z are as described below.

The number of repeat units n may be from 7 to 72 and relates to the molecular weight of this additive component. R₁ and R₂ may be independently hydrogen or an ester of a water soluble glycol. The glycol may be alkoxylated. The SMA ester copolymer may have different molar ratios of styrene (S)/maleic anhydride (MA) co-monomer compositions, such as a molar ratio (x: (y+z)) in the range from about 1:1 to 3:1 and more preferably from about 1.4:1 to 1.6:1. The molecular variables x, y, and z, relate to the molar ratios of S:MA such that x is from 1 to 4, a molar ratio of (x: (y+z)) is in the range from about 1:1 to 3:1, and the monoesterification molar ratio of (z/(y+z)) ranges from about 25 to 100%, more preferably 50 to 100%. The SMA ester copolymer can be any partial monoester of a styrene-maleic anhydride copolymer that is soluble to any degree in basic pH solutions having a pH greater than 8. The additive component may have a flashpoint greater than or equal to 150° C. and is compatible with polystyrene, such that the additive will impart acid functionality to the aromatic containing domain of a block co-polymer of a hot melt adhesive composition. These monoesters may have both acid and anhydride functionality. Particular examples of glycols which may provide the ester linkage for R₁ and R₂ of Formula I include, but are not limited to ethylene glycol, polyethylene glycol, methoxy polyethylene glycol, methoxy polyethylene-polypropylene glycol, and methoxy polyethylene-polybutylene glycol. The molecular weight of the glycol is preferably about 200 to 500. For example, the additive composition may be a methoxy polyethylene glycol ester of a styrene-maleic anhydride (SMA) copolymer, which defines a 75% total monoester, and an S:MA ratio of between about 1.4:1 to about 1.6:1.

In one or more embodiments, the one or more dicarboxylic acid moieties present in the polymeric backbone of the ester functionalized polymer are in accordance with Formula I, wherein R₁ and R₂ can be the same or different and are selected from H and any glycol ester, subject to the proviso that in at least one of the dicarboxylic add moieties at least one of R₁ or R₂ is the ester of a glycol. The glycol may be alkoxylated, as long as the glycol is water soluble. The one or more dicarboxylic acid moieties may be, for example, from about 25 to 100% esterified.

An exemplary embodiment of a process for producing an at least partial ester of a low molecular weight α,β ethylenically unsaturated anhydride-containing or acid-containing polymer includes first obtaining a commercially available styrene-maleic anhydride (SMA) copolymer, such as those manufactured and sold by TOTAL Petrochemicals and Refining, Inc. USA of Houston, Tex. The SMA copolymer is then added to a reactor that is precharged with an approximately stoichiometric amount of a methoxy polyethylene glycol for the approximately complete esterification of the MA while heating to a temperature of at least about 150° C., and held at that temperature until the esterification level reaches equilibrium, as measured by acid value titration. Once equilibrium is reached, then the ester is cooled and removed from the reactor.

The term “low molecular weight” according to the invention generally means a weight average molecular weight less than 50,000. When a low molecular weight carboxylic anhydride aromatic copolymer, such as a styrene-maleic anhydride, is used as part of an additive composition, the molecular weight may be affected by the degree of monoesterification, among other factors. The weight average molecular weight of the styrene-maleic anhydride copolymer may thus range from 1,000 to 50,000, or more preferably from 2,000 to 15,000. Similarly, when the ester functionalized C5 hydrocarbon polymer comprising a polymeric backbone and, pendent thereon, one or more dicarboxylic acid moieties in at least partial ester form is employed in the additive, the molecular weight may vary depending on the maleic anhydride content (e.g., the degree of maleinization) or by the degree of monoesterification, among other factors. The weight average molecular weight of the ester functionalized polymer may thus be in the range from 250 to 25,000, or more preferably from 500 to 10,000. The weight average molecular weight ranges are as measured by gel permeation chromatography (GPC) with polystyrene standards in tetrahydrofuran (THF).

In an embodiment, the additive composition may comprise the combination of an at least partial ester of a low molecular weight C5 hydrocarbon polymer and an at least partial ester of a low molecular weight α,β ethylenically unsaturated anhydride-containing or acid-containing hydrocarbon polymer, wherein the hydrocarbon polymer is selected from the group consisting of a maleic anhydride homopolymer, a maleic anhydride olefin copolymer, a maleic anhydride aromatic copolymer, combinations and mixtures thereof. Preferably, the additive composition includes an at least partial ester of a low molecular weight aliphatic C5 hydrocarbon polymer and an at least partial ester of a low molecular weight maleic anhydride vinyl aromatic copolymer, such as an at least partial ester of a low molecular weight styrene-maleic anhydride (SMA).

In another embodiment, the present invention is a caustic removable hot melt adhesive composition, more particularly a hot melt pressure sensitive adhesive composition, which includes a hot melt adhesive additive. The hot melt adhesive composition is caustic removable and includes a hot melt adhesive additive which comprises low molecular weight ester functionalized polymers which are capable of imparting acid functionality to the hot melt adhesive; and an adhesive resin selected from the group consisting of styrene-isoprene block copolymers, polyacrylate resins, poly ethylene vinyl acetate (EVA) resins, polystyrene butadiene resins, random styrenebutadiene (SBR) copolymers, styrene-butadiene block copolymers, styrene-isoprene-butadiene-styrene (SIBS), styrene-ethylene-propylene-styrene (SEPS), styrene-ethylene-butylene-styrene (SEBS) block copolymers, amorphous poly-α olefin (APAO) resins, and mixtures thereof; a tackifier; and/or a processing oil. The additive composition may comprise one or more of the ester functionalized polymers described above, such that acid functionality may be imparted into the aliphatic and aromatic hydrocarbon domains of the adhesive resin component of the hot melt adhesive composition.

In an example of this embodiment, the additive composition comprises an at least partial ester of a maleated aliphatic C5 hydrocarbon polymer and an at least partial ester of a low molecular weight maleic anhydride vinyl aromatic copolymer. For example, the additive may include (i) an at least partial ester of a maleic anhydride grafted aliphatic C5 hydrocarbon polymer and (ii) an at least partial ester of a low molecular weight styrene-maleic anhydride (SMA) copolymer. The ratio of (i) to (ii) in the additive composition may be within the range of about 5:1 to 1:5.

The formulations disclosed herein are particularly useful for labels on products which are to be recycled. During manufacture of a caustic removable hot melt adhesive composition according to one of the embodiments of the present invention, an additive package is added during the compounding of the adhesive. The additive package may contain a combination of one or more of the ester functionalized polymers described above. The components of the additive can be added in varying amounts. In some embodiments, from 3 to about 15 weight percent of each component of the additive is used. For an embodiment employing a low molecular weight styrene-maleic anhydride copolymer ester and a low molecular weight maleated C5 hydrocarbon polymer ester as components of the additive, preferably equal parts from about 3 to about 12 weight percent of each component is used. More preferably, the total weight content of the additive composition (i.e., total weight content of all component polymers of the additive composition) in the said hot melt adhesive composition is generally at least about 5%, preferably about 8%.

An exemplary conventional hot melt adhesive, to which one of the disclosed additives may be added, includes a styrene-isoprene-styrene (SIS) block copolymer, a hydrocarbon (C5 or C5/C9) tackifying resin, a rosin ester tackifler, and/or a process oil. A SIS block copolymer may be employed in the hot melt adhesive, such as that which is sold by Kraton Performance Polymers Inc. of Houston, Tex. under the trade name Kraton D-1113. A C5 hydrocarbon tackifying resin may be utilized, such as that which is sold by TOTAL Petrochemicals and Refining, Inc. U.S.A. of Houston, Tex. under the trade name Wingtack ET. A naphthenic process oil may be used in the hot melt adhesive as well, such as the one sold under the trade name Nyflex 222B by Nynas AB of Stockholm, Sweden. As is known to one skilled in the art, conventional hot melt adhesives may include a variety of other components including, but not limited to, starches, waxes, plasticizers, anti-oxidants, stabilizers, pigments, dyes, biocides, flame retardants, antistatic agents, or fillers. For example, the hot melt adhesive may include Ethanox 310, an antioxidant sold by Albemarle Corporation of Baton Rouge, La.

The additive may be introduced to a conventional hot melt adhesive by any process known to one skilled in the art. For example, when an at least partial ester of an SMA copolymer and an at least partial ester of a maleated C5 hydrocarbon polymer ester are employed as the additive polymers, they may be introduced separately from each other and separate from, or in combination with, any of the individual components of the conventional hot melt adhesive. As a further example, the additive may be introduced to the components of a conventional hot melt adhesive comprising a styrene-isoprene-styrene (SIS) block copolymer, a hydrocarbon (C5-C9) tackifying resin, and a process oil. The at least partial ester of an SMA copolymer may be prepared from a commercially available low molecular weight styrene maleic anhydride copolymer product with variable maleic anhydride contents, such as that sold by TOTAL Petrochemicals and Refining Inc. U.S.A. of Houston, Tex. The maleated C5 hydrocarbon polymer may also be a commercially available product, such as that sold by TOTAL Petrochemicals and Refining Inc. U.S.A. of Houston, Tex. that is esterified prior to addition. A process oil, such as mineral oil, may be added last. The hot melt adhesive containing the additive may be mixed with a sigma blade mixer, for example, until it is homogeneous.

In yet another embodiment, a caustic removable adhesive label is provided comprising a substrate and a caustic removable hot melt adhesive composition that includes at least one hot melt adhesive additive. The hot melt adhesive composition can be used in hot melt adhesive labels, particularly in hot melt pressure sensitive adhesive labels, and more particularly for recyclable glass articles which may be containers such as bottles. The labels can be removed with caustic, for example in a hot caustic bath, when the objects are recycled. The hot melt adhesive additive comprises low molecular weight ester functionalized polymers which are capable of Imparting acid functionality to the hot melt adhesive; an adhesive resin selected from the group consisting of styrene-isoprene block copolymers, hydrocarbon tackifying resins, polyacrylate resins, poly ethylene vinyl acetate (EVA) resins, polystyrene butadiene resins, random styrenebutadiene (SBR) copolymers, styrene-butadiene block copolymers, styrene-isoprene-butadiene-styrene (SIBS), styrene-ethylene-propylene-styrene (SEPS), styrene-ethylene-butylene-styrene (SEBS) block copolymers, amorphous poly-α olefin (APAO) resins, and mixtures thereof; and a tackifier and/or processing oil. The adhesive composition is applied to the substrate for adhesion to an article. Alternatively or additionally, the adhesive may be applied to the article with the substrate or label applied thereon, as would be appreciated by one having ordinary skill in the art. The label, after application of the caustic removable hot melt adhesive composition, may be adhered to an article such as a glass bottle. In at least one embodiment, the caustic removable adhesive label contains a hot melt adhesive composition including an additive composition, in which the additive composition comprises a combination of polymers. Without being bound by theory, it is believed that the acid and/or anhydride groups of the additive impart caustic solubility to the adhesive composition despite the presence of insoluble components such as styrene-isoprene-styrene (SIS) tri-block copolymer, hydrocarbon tackifying resin, and/or process oil. The formulations disclosed herein enable the manufacturing of a hot melt adhesive which has favorable water resistance and viscoelastic properties for adhesion to a surface and substrate, for example the retention of a label on a glass bottle, while also imparting caustic removability to the hot melt adhesive formula. This allows for strong retention and adhesion characteristics when they are desired, but also removability of the hot melt adhesive from the surface of the article to which it is applied when it is necessary as in the recycling process.

The hot melt adhesive containing the additive may be applied to the label and/or the surface by various processes known to one skilled in the art. In one representative process, the caustic removable hot melt adhesive of the present invention is melted and poured onto a blade coater. The blade coater can be employed to apply a thin film of the caustic removable hot melt adhesive to a release liner to which a face stock is laminated. The laminate may then be cut into label size strips for application to an article's surface, such as a glass bottle.

In a further embodiment, an article having a label adhered with a caustic removable hot melt adhesive composition containing an additive as described is provided. For hot melt adhesive labels, particularly for hot melt pressure sensitive adhesive labels, the adhesive is coated onto a release liner, which is then immediately laminated with a label facestock, which could be paper or plastic. The article may be, for example, a container which may be made of any suitable material including, for example, glass, metal (e.g., stainless steel), or plastic (e.g., high density polyethylene). The label is then applied to an article such as a glass bottle for identification and/or decorative purposes. The label adheres to the article with good adhesion properties, and the article and label are water resistant (i.e., resistant to water having a substantially neutral pH). The label becomes removable from the article upon being submerged in, or otherwise treated with, a caustic bath having a pH greater than 8. After the contents of the article have been used, it may be desirable to recycle the article. To remove the label, articles can be placed in a hot caustic bath, which causes the adhesive to dissolve and/or delaminate from the article. The clean bottle or other article can then more easily be recycled without the contamination of the label and/or the adhesive. Removal of the hot melt adhesive is made possible by adding the additive of the present invention.

### Examples

The advantageous properties of the disclosed formulations can be observed by reference to the following non-limiting examples.

### Control Adhesive

The Control Adhesive (Formula 10) was compounded with typical procedures known to those skilled in the art. SIS Polymer (Kraton D1113) was first added with an anti-oxidant (Ethanox 310) to a hot, approximately 150° C., sigma-blade mixer under nitrogen blanket. The SIS was masticated over approximately ten minutes. After complete mastication of the SIS, hydrocarbon tackifying resin (Wingtack ET) was added in three increments over approximately 30 minutes. After complete incorporation of the resin, process oil (Nyflex 222B) was added over approximately 10 minutes.

### Adhesive Composition Samples

Nine experimental adhesive formulas were prepared (Formulas 1 through 9) each containing an additive composition comprising a partial ester of a low molecular weight maleated aliphatic C5 hydrocarbon polymer having a number average molecular weight (Mn) of 370, a weight average molecular weight (Mw) of 500, was 9% wt/wt maleated, and esterified with cetyl alcohol to an esterification ratio of 50%, in accordance with at least one embodiment of the present invention, and the additive further contained a low molecular weight product with high maleic anhydride content, a styrene: maleic anhydride (S:MA) ratio of 1.5:1, a number average molecular weight (Mn) of 2,900 and a weight average molecular weight (Mw) of 7,000, and was esterified with an alkoxyglycol, such as methoxy polyethylene glycol, to an esterification ratio of 75%. The molecular weight ranges were measured by GPC (gel permeation chromatography) with polystyrene standards in THF (tetrahydrofuran).

The caustic removable hot melt adhesive with additive was prepared in the following general manner using the same general procedure as the control adhesive. Adhesive compositions were compounded by first adding the SIS Polymer (Kraton D1113), and anti-oxidant (Ethanox 310) to a hot, approximately 150° C., sigma-blade mixer under nitrogen blanket. The mixture was mixed until masticated over approximately ten minutes. After complete mastication of the SIS, the hydrocarbon tackifying resin (Wingtack ET) was added in three increments over approximately 30 minutes. After complete incorporation of the resin, the additive composition and the process oil (Nyflex 222B) was added sequentially over approximately 10 minutes. Table 1 details the composition of the adhesive formulations tested.

TABLE 1
Sample Formulas Tested (Weight in Percent)

| Sample | | Wingtack ET | | Antioxidant | Ratio of Aromatic | Totol Additive in |
|---|---|---|---|---|---|---|
| Formula | Kraton | Tackifying | Nyflex 222B | Ethanox | Additive to | weight percent |
| Number | D1113 | Resin | Process Oil | 310 | Aliphatic Additive | of adhesive |
| 1 | 36.2 | 43.4 | 7.2 | 0.9 | 80/20 | 12.3 |
| 2 | 37.5 | 45.0 | 7.5 | 1.0 | 60/40 | 9.1 |
| 3 | 38.9 | 46.7 | 7.8 | 1.0 | 80/20 | 5.7 |
| 4 | 38.9 | 46.7 | 7.8 | 1.0 | 40/60 | 5.7 |
| 5 | 36.2 | 43.4 | 7.2 | 0.9 | 40/60 | 12.3 |
| 6 | 37.5 | 45.0 | 7.5 | 1.0 | 60/40 | 9.1 |
| 7 | 37.5 | 45.0 | 7.5 | 1.0 | 60/40 | 9.1 |
| 8 | 39.5 | 47.4 | 7.9 | 1.0 | 60/40 | 4.2 |
| 9 | 38.2 | 45.8 | 7.6 | 1.0 | 50/50 | 7.4 |
| 10 | 41.2 | 49.5 | 8.2 | 1.1 | 0 | 0.0 |
| (Control) | | | | | | |

The sample formulas were initially tested for compatibility. It is noted that the combination additive of the present invention was found to be compatible with the components of conventional hot melt adhesives. The caustic removable hot melt adhesive and additive mixed uniformly during compounding with a Sigma mixer. There was no phase separation at room temperature or in the 170° C. oven-heated samples (i.e., uniform cross-section).

Dynamic Mechanical Analysis was also performed on these samples, using a TA Instruments Rheometer AR 2000 on an 8 mm parallel plate. Dynamic Mechanical Analysis (DMA) is a thermo-mechanical analytical technique used to study the characteristics of materials such as the viscoelastic nature of polymers and polymer blends. An oscillating force is applied to a sample of material and the resulting displacement of the sample is measured. The samples can be either solids, which are tested by linearly applied strains, or melts or liquids, which are normally tested in shear. The DMA sample deforms under the applied load. From this the stiffness of the sample can be determined, and the sample modulus can be calculated. It is possible to determine the damping properties of a material by measuring the time lag in the displacement compared to the applied force. The time lag is reported as a phase lag angle. The damping is called tan delta (δ), as it is reported as the tangent of the phase lag. Viscoelastic materials such as polymers typically exhibit the properties of a glass (high modulus) at low temperatures, and those of a rubber (low modulus) at higher temperatures. This change of state, i.e., glass transition or alpha relaxation, can be observed by scanning the temperature during a DMA experiment. The samples were observed for broadening of the tan δ peak, and/or the appearance of a second peak indicating a change of state, under the DMA. Table 2, below, presents the numerical results of the Dynamic Mechanical Analysis.

TABLE 2
Dynamic Mechanical Analysis

| | | | | | Storage | Storage |
|---|---|---|---|---|---|---|
| Sample | Peak | Temperature, | Temperature, | Temperature, | Modulus G′ | Modulus G′ |
| Formula | tan δ | 1st Crossover | 2nd Crossover | 3rd Crossover | at 25° C. | at 40° C. |
| Number | ° C. | ° C. | ° C. | ° C. | Pa | Pa |
| 1 | −2.7 | −18.2 | 13.7 | 111.5 | 48520 | 30350 |
| 2 | −2.8 | −18.2 | 13.7 | 107.4 | 45110 | 28740 |
| 3 | −0.8 | −17.2 | 13.7 | 110.5 | 55490 | 36760 |
| 4 | −6.9 | −22.3 | 8.6 | 109.4 | 50270 | 33510 |
| 5 | −1.8 | −18.2 | 13.8 | 104.3 | 45910 | 28840 |
| 6 | −1.7 | −17.1 | 13.8 | 107.4 | 49580 | 33160 |
| 7 | −1.8 | −18.2 | 13.7 | 109.4 | 48750 | 33440 |
| 8 | −1.8 | −17.1 | 13.7 | 110.5 | 53060 | 35760 |
| 9 | −1.5 | −18.2 | 14.8 | 106.9 | 42930 | 26540 |
| 10 | −1.4 | −18 | 16.3 | 104.1 | 47750 | 31620 |
| (Control) | | | | | | |

The overall results, as shown in Table 2, demonstrate that the essential viscoelastic performances of the adhesive composition are not significantly affected when an additive according to an embodiment of the present invention is added to a conventional hot melt adhesive. Visual observations were made of the formulations in a Sigma mixer, of oven heated samples heated to 170° C., and of the applied film during coating. The results showed compatible transparent adhesive films for the adhesive of the invention containing the additive.

An adhesive label of the present invention may be prepared by various methods known to one having ordinary skill in the art. In one preferred embodiment, the adhesive is melted and poured onto a blade coater so that a thin film of it can be applied to a release liner to which a face stock is laminated. The laminate is then cut into label size strips. To test the label, the release liner is removed and the label is applied to a surface and rolled with a 4.5 lb. roller. Typical adhesive properties such as tack, peel and shear can be measured and compared with adhesives not containing the combination additive of the present invention. For adhesion tests, the adhesives were heated to 170° C. and coated onto a release liner and Immediately laminated to a 2 mil thick (50 micron) polyethylene terephthalate (PET) polyester film. The initial adhesive properties were measured after aging the coated adhesive sheets for 24 hours at 23° C. and 50% relative humidity (R.H.). Aged adhesive properties were measured after aging the coated sheets for 1 week at 70° C. followed by a minimum of 24 hours at 23° C. and 50% R.H. The aged adhesion results, when compared to the initial adhesion properties, showed that the adhesion properties were not significantly different.

The sample formulas were tested using standard test methods established by the Pressure Sensitive Tape Council (PSTC). The sample formulas were tested for peel strength, according to PSTC Method 101 “International Standard for Peel Adhesion of Pressure Sensitive Tapes.” Peel adhesion is the force required to remove a pressure sensitive tape from a test panel or its own backing at a controlled angle and at a standard rate and condition. The sample formulas were tested for their adhesion to stainless steel (SS) and glass surfaces at an angle 180 degrees. The sample formulas were further tested using HDPE, SS, and glass surfaces for loop tack under PSTC Method 16. The results of these tests are shown in Table 3 below.

TABLE 3
Initial Adhesion Performance Comparison

| | | Total | | | | | | Shear |
|---|---|---|---|---|---|---|---|---|
| | | Additive | | | | | Shear off | Adhesion |
| | Aromatic/ | in | Peel | Peel | Loop | Loop | SS | Failure |
| Sample | Aliphatic | Adhesive | Adhesion, | Adhesion, | Tack, | Tack, | ½″ × ½″ × | Temperature, |
| Formula | Additive | Formula | off SS | off Glass | off SS | off Glass | 500 g | off SS |
| Number | Ratio | % | lbs/in | lbs/in | lbs | lbs | Min. | ° F. |
| 1 | 80/20 | 12.3 | 6.4 | 5.5 | 7.9 | 8.7 | 433 | 99 |
| 2 | 60/40 | 9.1 | 6.9 | 6.0 | 7.6 | 9.4 | 413 | 93 |
| 3 | 80/20 | 5.7 | 6.8 | 6.4 | 7.3 | 6.8 | 1303 | 117 |
| 4 | 40/60 | 5.7 | 6.5 | 5.9 | 6.7 | 6.7 | 752 | 119 |
| 5 | 40/60 | 12.3 | 6.1 | 5.6 | 7.8 | 8.0 | 481 | 105 |
| 6 | 60/40 | 9.1 | 5.0 | 5.9 | 7.9 | 8.2 | 734 | 114 |
| 7 | 60/40 | 9.1 | 6.0 | 5.8 | 6.4 | 7.0 | 1349 | 116 |
| 8 | 60/40 | 4.2 | 6.1 | 6.0 | 7.0 | 7.3 | 1345 | 122 |
| 50 | 50/50 | 7.4 | 6.2 | 5.8 | 7.0 | 7.5 | 776 | 113 |
| 10 | 0 | 0.0 | 5.8 | 5.9 | 8.2 | 8.3 | 828 | 122 |
| (Control) | | | | | | | | |

The components of the adhesive may be adjusted to achieve specifically desired adhesion properties. The amount of each component can be varied to balance adhesion characteristics and Initial compatibility with conventional hot melt formulations, while increasing water-resistance and caustic removability. For example, when a combination of a partial ester of a low molecular weight SMA copolymer and partial ester of a maleated aliphatic C5 hydrocarbon polymer is used as the additive, an acceptable overall adhesive performance was observed by the peel and loop tack tests. Furthermore, the combination additive was very compatible with conventional hot melt adhesive formulas containing SIS block copolymers, hydrocarbon resins, tackifier resins, and process oil with overall unaffected viscoelastic performance metrics, as shown in Table 2 above.

The additive of the present invention was found to be compatible with conventional hot melt adhesives while also enabling them to be caustic removable. This additional characteristic is useful for many purposes, particularly in the recycling process. Samples of Formulas 1 through 10 were tested for caustic removability. The adhesive Formulas were heated to 170° C. and coated onto 12 Inch by 1 Inch (30.48 cm by 2.54 cm) adhesive strips of unbleached Kraft 30 lbs/ream paper to test caustic removability and cold water resistance. The labels were adhered to flat glass panels and rolled with a 4.5 lb roller. The glass panels were immersed in a hot caustic bath consisting of 2.5% sodium hydroxide in water, heated to 80° C. Slight agitation was applied to the caustic bath.

The samples were timed for how long it took to remove the labels from the panels and the adhesion was rated for the amount of adhesive residue left on the panels. Glass panels are kept immersed in the aqueous solution of NaOH at 2.5% at 80° C. for a maximum of 5 minutes. Then, the strip adhesion (i.e., caustic removability) is measured and given a rating from 0 to 5, where 5 represents easy removal from the panel and no residue left on the panel and 0 represents no removal of the test strip (i.e., the adhesive remains on the panel).

TABLE 4
Caustic Removability Test Results

| | | Total % of | Caustic | Caustic |
|---|---|---|---|---|
| | Aromatic/ | Additive | Removability | Removability |
| Sample | Aliphatic | in | Rating Paper | Rating PET Film |
| Formula | Additive | Adhesive | to Glass | to Glass |
| Number | Ratio | % | Rating | Rating |
| 1 | 80/20 | 12.3 | 4.8 | 4.5 |
| 2 | 60/40 | 9.1 | 4.8 | 4.5 |
| 3 | 80/20 | 5.7 | 4.5 | 3.0 |
| 4 | 40/60 | 5.7 | 4.8 | 2.5 |
| 5 | 40/60 | 12.3 | 5.0 | 2.3 |
| 6 | 60/40 | 9.1 | 5.0 | 4.5 |
| 7 | 60/40 | 9.1 | 5.0 | 2.0 |
| 8 | 60/40 | 4.2 | 4.8 | 1.5 |
| 9 | 50/50 | 7.4 | 4.7 | 4.5 |
| 10 (Control) | 0 | 0.0 | 0.0 | 0.0 |

The results in Table 4 above show that the samples containing an additive composition containing both a partial ester of a low molecular weight SMA copolymer and partial ester of a maleated aliphatic C5 hydrocarbon polymer on paper labels are easily removable with a rate of 4 to 5 on glass. The PET filmic labels all removed easier than the control (without additives) but the best removability was achieved with samples 1, 2, 6 and 9. As would be appreciated by one having ordinary skill in the art, and as discussed above, the additive composition and the adhesive composition may be varied to achieve specifically desired adhesion and caustic removability properties. The amount of the additive components can be varied to balance adhesion characteristics and compatibility with conventional hot melt formulations, while increasing water-resistance and caustic removability.

While preferred embodiments of the Invention have been shown and described herein, it will be understood that such embodiments are provided by way of example only. Numerous variations, changes, and substitutions will occur to those skilled in the art without departing from the spirit of the invention. Accordingly, it is intended that the appended claims cover all such variations as fall within the spirit and scope of the invention.

The present invention, therefore, is well adapted to carry out the objects and attain the ends and advantages mentioned, as well as others inherent therein. While the invention has been depicted and described and is defined by reference to particular preferred embodiments of the Invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. An additive composition for imparting caustic removability to a hot melt adhesive, the additive composition comprising:
a C5 hydrocarbon polymer comprising a first at least partially esterified dicarboxylic-acid group containing an ester of a C12 to C18 monoalcohol; and
an aromatic copolymer comprising a second at least partially esterified dicarboxylic-acid group containing an ester of a water soluble glycol,
wherein the first and second dicarboxylic-acid group are independently derived from a functionalizing agent selected from the group consisting of maleic add, maleic anhydride, fumaric add, itaconic add, tetrahydrophthalic acid, and tetrahydrophthalic anhydride, and combinations thereof.

2. The additive composition of claim 1, wherein the C5 hydrocarbon polymer has a molecular weight less than or equal to 50,000.

3. The additive composition of claim 2, wherein the C5 hydrocarbon polymer has a molecular weight of 500 to 10,000.

4. The additive composition of claim 1, wherein the C5 hydrocarbon polymer contains an aromatic monomer content of up to 30% by weight of the C5 hydrocarbon polymer.

5. The additive composition of claim 1, wherein the aromatic copolymer has a molecular weight less than or equal to 50,000.

6. The additive composition of claim 5, wherein the aromatic copolymer has a molecular weight of 200 to 15,000.

7. The additive composition of claim 1, wherein the water soluble glycol is selected from the group consisting of ethylene glycol, polyethylene glycol, methoxy polyethylene glycol, methoxy polyethylene-polypropylene glycol, and methoxy polyethylene-polybutylene glycol.

8. The additive composition of claim 7, wherein the water soluble glycol is methoxy polyethylene glycol.

9. The additive composition of claim 8, wherein the methoxy polyethylene glycol has a molecular weight of 200 to 500.

10. The additive composition of claim 1, wherein the aromatic copolymer is a styrene-maleic anhydride copolymer.

11. The additive composition of claim 10, wherein the styrene-maleic anhydride copolymer has a monoesterification molar ratio of 25 to 100%.

12. The additive composition of claim 10, wherein the styrene-maleic anhydride copolymer has an S:MA ratio of 1:1 to 3:1.

13. The additive composition of claim 1, wherein the C5 hydrocarbon polymer has a maleic anhydride content from 1% to 50% wt/wt.

14. The additive composition of claim 1, wherein the C5 hydrocarbon polymer has a monoesterification molar ratio of 25 to 100%.

15. The additive composition of claim 1 having a flashpoint greater than or equal to 150° C.

16. The additive composition of claim 1 being at least partially soluble in a caustic solution having a pH of at least 8.

17. A hot melt adhesive composition comprising:
an adhesive resin;
an additive composition according to claim 1;
a tackifler; and
a processing oil.

18. The hot melt adhesive composition according to claim 17, wherein the adhesive resin is selected from the group consisting of styrene-isoprene block copolymers, hydrocarbon tackifying resins, polyacrylate resins, poly ethylene vinyl acetate (EVA) resins, polystyrene butadiene resins, random styrenebutadiene (SBR) copolymers, styrene-butadiene block copolymers, styrene-Isoprene-butadiene-styrene (SIBS), styrene-ethylene-propylene-styrene (SEPS), styrene-ethylene-butylene-styrene (SEBS) block copolymers, amorphous poly-α olefin (APAO) resins, and mixtures thereof.

19. The hot melt adhesive composition according to claim 17, wherein the total weight content of the additive composition in the hot melt adhesive composition is at least 5%.
